(19) United States
(12) Patent Application Publication
(10) Pub. No.: US 2007/0210678 A1
(43) Pub. Date: Sep. 13, 2007

(54) Polymer Actuator

(75) Inventors: Tatsuya Hattori, Saitama-ken (JP); Pu Qian, Saitama-ken (JP)

Correspondence Address: LAHIVE & COCKFIELD, LLP, ONE POST OFFICE SQUARE, BOSTON, MA, 02109-2127, US

(73) Assignee: HONDA MOTOR CO., LTD., TOKYO (JP)

(21) Appl. No.: 10/593,205

(22) PCT Filed: Mar. 14, 2005
(86) PCT No.: PCT/JP05/04477

§ 371 Date: Sep. 18, 2006

(30) Foreign Application Priority Data
Mar. 17, 2004 (JP) 2004-075750

(51) Int. Cl. H02N 2/02

(52) U.S. Cl. 310/366; 310/311

(57) ABSTRACT

A polymer actuator comprising a conductive powder compact, an ion donor, a work electrode and a counter electrode, contracting or extending by a voltage applied between the work electrode and the counter electrode, wherein the powder compact comprises the conductive powder containing a conductive polymer and a conductive material other than the conductive powder.

### FIELD OF THE INVENTION

The present invention relates to a polymer actuator generating large displacement and power, the displacement being able to be utilized at both contraction and extension.

### BACKGROUND OF THE INVENTION

In the fields using electromagnetic motors such as robots, cutting machines, automobiles, etc., demand has been mounting to reduce the weight of driving systems. However, because the power densities of the electromagnetic motors depend on the weight of motors, the weight reduction of actuators utilizing the electromagnetic motors is limited. It has been thus desired to develop a small-sized, lightweight actuator capable of providing high output.

As actuators, which can be made smaller in size and weight, polymer actuators have recently been attracting much attention. Known as the polymer actuators are a gel actuator using a conductive polymer gel, a polymer membrane actuator using a conductive polymer membrane, etc.

An example of the conductive polymer membrane actuator has a conductive polymer membrane and metal electrodes attached to its surfaces. The metal electrodes are formed on the conductive polymer membrane by such methods as chemical plating, electroplating, vapor deposition, sputtering, coating, pressure bonding, welding, etc. When potential difference is provided to an assembly of a conductive polymer membrane and metal electrodes in a water-containing state, bending and deformation occur in the conductive polymer membrane, and they can be utilized as a driving force.

However, the metal electrodes, which are plate like and are not elastic, prevent the conductive polymer membrane from extension and/or contraction so that the assembly cannot deform enough. Accordingly, the actuator having the assembly of the conductive polymer membrane and the plate metal electrodes does not utilize enough deformation of the conductive polymer membrane so that it does not produce large amount of displacement. In addition, after repeated use, plate metal electrodes easily peel off from the conductive polymer membrane to decrease a response speed of the actuator.

JP 2003-152234A discloses an actuator comprising an electrolyte sandwiched by electrodes, each electrode being composed of a conductive polymer, and a conductor in the form of powder, a net or a porous body, which is in electrical contact with the conductive polymer, so that the actuator deforms when voltage is applied to the electrodes. This actuator has a conductor layer, and a pair of conductive polymer membranes sandwiching the conductor layer, and the conductor layer and the conductive polymer membranes are curved when electric current is supplied. The conductive polymer layer can be produced by electrolytic polymerization on the conductor.

The conductor in the form of powder, a net or a porous body can easily follow the deformation of the conductive polymer, so that the extension and/or contraction of the conductive polymer is not so prevented. JP 2003-152234A thus describes that the electrodes not in the form of a plate but in the form of powder, a net or a porous body can shorten the time necessary for the actuator to achieve the maximum displacement. However, because this actuator is bent like the above-described actuator having plate metal electrodes, it is difficult to control the amount and position of displacement. In addition, though large power is generated when the polymer membrane contracts, only small power is generated when it extends. This actuator is inefficient because of failure to utilize its displacement at the time of extension. It is also costly, because the production of the conductive polymer membrane by electrolytic polymerization takes an extremely long period of time.

### OBJECTS OF THE INVENTION

Accordingly, an object of the present invention is to provide a polymer actuator mass-producible at a low cost, which can generate large displacement and power with easy control of displacement, the displacement being able to be utilized not only when a driver constituted by the conductive polymer contracts but also when it extends.

### DISCLOSURE OF THE INVENTION

As a result of intense research in view of the above object, the inventors have found that an actuator comprising a powder compact containing a conductive polymer powder, an ion donor, a work electrode and a counter electrode, which contracts or extends by voltage applied between the work electrode and the counter electrode, generates large displacement and power so that displacement at both contraction and extension can be utilized, and that because the actuator generates linear displacement, the control of displacement, etc. is easy. The inventors have also found that the actuator shows excellent response when the powder compact contains a conductive material other than conductive polymer powder, such as a platinum powder, etc. The present invention has been completed based on these findings.

Thus, the polymer actuator of the present invention comprises a conductive powder compact, an ion donor, a work electrode, a counter electrode, the powder compact comprising conductive powder containing a conductive polymer and a conductive material other than the conductive powder, whereby the actuator contracts or extends by voltage applied between the work electrode and the counter electrode.

The conductive polymer preferably has a conjugated structure. It is more preferably at least one selected from the group consisting of polypyrrole, polythiophene, polyaniline, polyacetylene, and their derivatives.

The conductive material is preferably at least one selected from the group consisting of platinum, gold, palladium, nickel and carbon. The conductive material is preferably in a powdery, net and/or porous form.

The ion donor is preferably in the form of a solution, a sol, a gel or a combination thereof. The ion donor preferably contains an amphiphatic compound, and has a binder function.

A preferred example of the actuator of the present invention comprises the powder compact in contact with the work electrode, and the counter electrode disposed in the ion donor at a position separate from the powder compact. Another example of the actuator preferably comprises pluralities of powder compacts and work electrodes alternately arranged in tandem.

The ratio of the conductive material to the powder compact is preferably 1 to 99% by mass. The powder compact has preferably electric conductivity of 10⁻³ to 10⁵ S/cm. The conductive powder preferably has electric resistance of 10⁻⁴Ω to 1 MΩ. The conductive polymer preferably has an average particle size of 10 nm to 1 mm.

### BRIEF DESCRIPTION OF THE DRAWINGS

FIG. 1 is a vertical cross-sectional view showing one example of the polymer actuator of the present invention.

FIG. 2 is a cross-sectional view taken along the line A-A in FIG. 1.

FIG. 3 is a cross-sectional view showing an extendable and contractible powder compact in the polymer actuator, in which (a) shows the powder compact to which current is not supplied, (b) shows the extended powder compact, and (c) shows the contracted powder compact.

FIG. 4(a) is an enlarged cross-sectional view showing one example of the powder compact containing a powdery conductive material.

FIG. 4(b) is an enlarged cross-sectional view showing another example of the powder compact containing a powdery conductive material.

FIG. 4(c) is an enlarged cross-sectional view showing a powder compact containing a conductive material in the form of fibers.

FIG. 4(d) is an enlarged cross-sectional view showing a powder compact containing a conductive material in the form of powders and fibers.

FIG. 4(e) is an enlarged cross-sectional view showing a powder compact containing a net conductive material.

FIG. 4(f) is an enlarged cross-sectional view showing a powder compact containing a porous conductive material.

FIG. 5 is a vertical cross-sectional view showing another example of the polymer actuator of the present invention.

FIG. 6 is a cross-sectional view taken along the line B-B in FIG. 5.

FIG. 7 is a vertical cross-sectional view showing a further example of the polymer actuator of the present invention.

FIG. 8 is scanning electron photomicrograph (SEM) of platinum powder.

FIG. 9 is a graph showing the variation of electric current and extension/contraction ratios with time in the actuator of Example 2, to which voltage was applied.

FIG. 10 is a scanning electron photomicrograph of a platinum-containing polypyrrole disk.

FIG. 11 is a photograph of a platinum-containing polypyrrole disk taken by a scanning electron microscope equipped with an energy dispersive x-ray spectrometer (SEM-EDX).

FIG. 12 is a graph showing the change of electric current and an extension/contraction ratio with time in the actuator of Comparative Example 1 when voltage was applied.

FIG. 13 is a graph showing the relations between the maximum extension/contraction ratio and the time for achieving 50% of the maximum extension/contraction ratio, and the platinum content in the platinum-containing polypyrrole disks.

### DESCRIPTION OF THE PREFERRED EMBODIMENTS

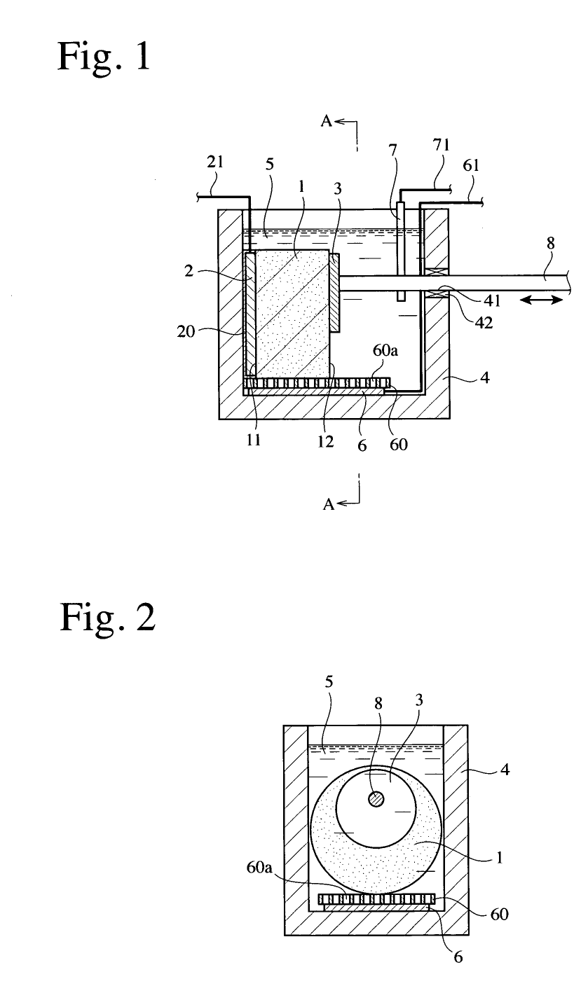

FIG. 1 shows one example of the polymer actuator of the present invention. The polymer actuator shown in FIG. 1 comprises a powder compact 1 comprising a conductive powder, a work electrode 2 fixed to a fixed end 11 of the powder compact 1, a movable plate 3 fixed to a driving end 12 of the powder compact 1, a cell 4 containing the powder compact 1, the work electrode 2 and the movable plate 3, and a counter electrode 6 lying at the bottom of the cell 4. The powder compact 1 is soaked in an ion donor 5 in the cell 4. A reference electrode 7 is soaked in the ion donor 5. In FIG. 1, the thickness of the work electrode 2 and the counter electrode 6 is exaggerated.

The powder compact 1 is preferably in a planar shape as thick as 0.1 to 20 mm. When it is thinner than 0.1 mm, it is easily broken, resulting in difficulty in handling. When it is thicker than 20 mm, the absorption and desorption of an electrolyte, etc. in the ion donor 5 are too slow, resulting in the powder compact 1 with poor response. Though the powder compact 1 is in a disk shape in FIGS. 1 and 2, it may be in a prism shape, etc.

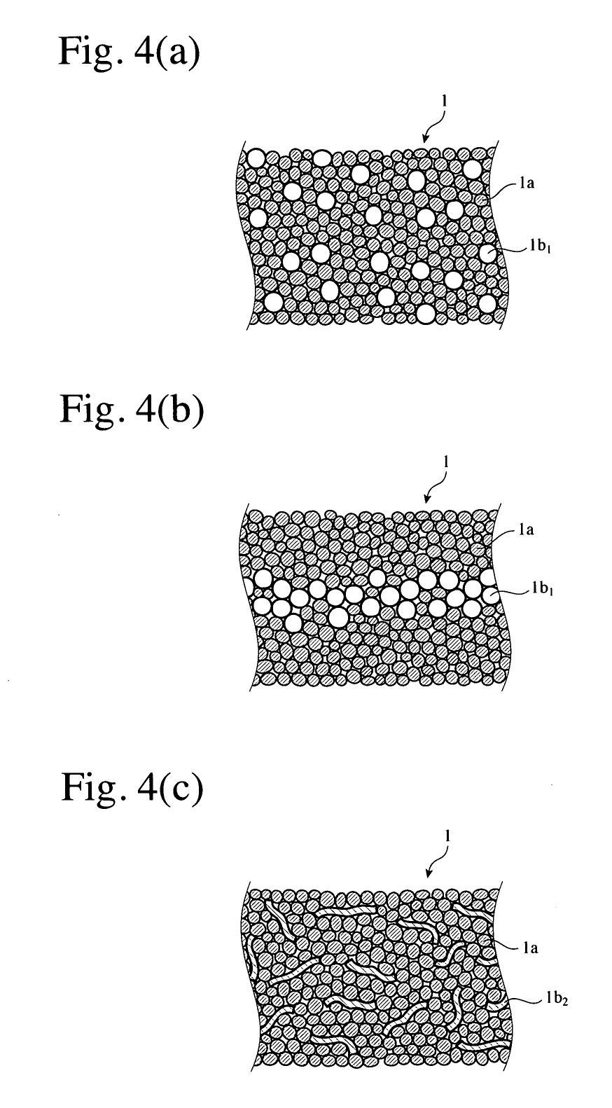

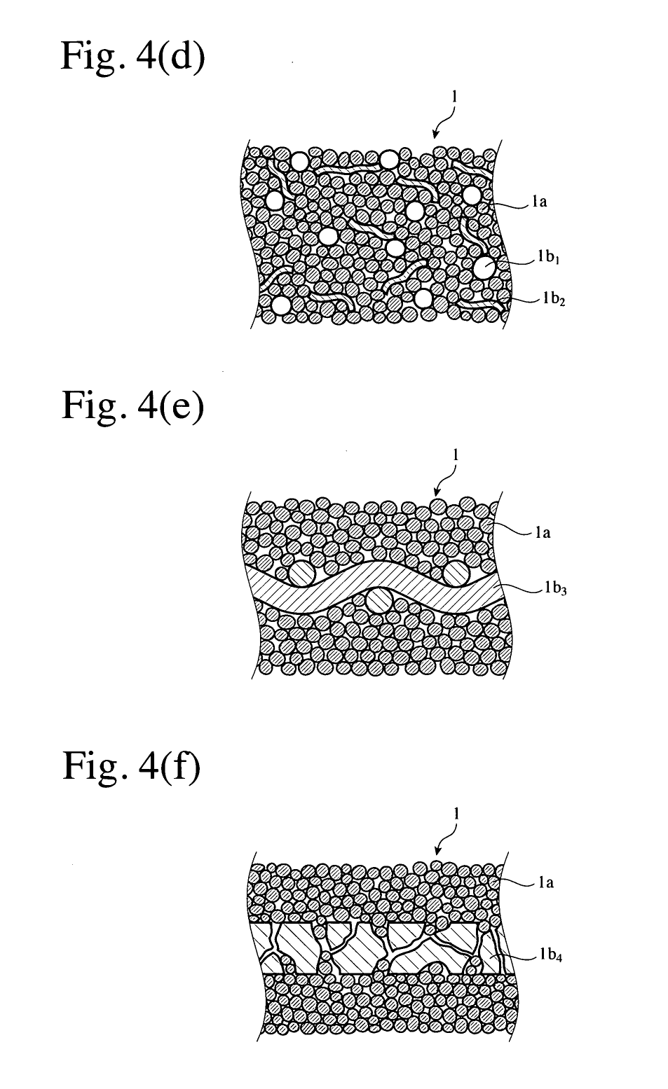

FIG. 4 is an enlarged, cross-sectional view showing the powder compact 1. The powder compact 1 is a compressed body formed with conductive powder 1a and a conductive material 1b other than the conductive powder 1a. FIG. 4 schematically shows the construction of the powder compact 1, with the sizes and ratios of the conductive powder 1a and the conductive material 1b, etc. exaggerated. The conductive material 1b is in contact with the conductive powder 1a in the powder compact 1. The conductive material 1b is not particularly restricted to powder as long as it can be integrally compressed with enough contact with the conductive powder 1a. The powdery conductive material 1b₁ may be dispersed in the conductive powder 1a as shown in FIG. 4(a), or sandwiched by layers of the conductive powder 1a as shown in FIG. 4(b). In the example shown in FIG. 4(c), a fibrous conductive material 1b₂ is dispersed the conductive powder 1a. The fibrous conductive material 1b₂ and the powdery conductive material 1b₁ may be dispersed together in the conductive powder 1a [FIG. 4(d)]. As shown in FIG. 4(e) or (f), layers of the conductive powder 1a may sandwich a net-shaped, conductive material 1b₃ or a porous, planar, conductive material 1b₄. The conductive powder 1a preferably enters into the pores of the net-shaped, conductive material 1b₃ or the porous, planar, conductive material 1b₄, so that there is large contact area between them, resulting in the powder compact 1 with large conductivity.

A ratio of the conductive material 1b to the powder compact 1 is preferably 0.01 to 99% by mass, more preferably 0.1 to 30% by mass. When the ratio is less than 0.01% by mass, the conductivity is not improved enough. When the ratio is over 99% by mass, the expansion and contraction of the powder compact 1 are too small.

The conductive powder preferably has electric resistance of 10⁻⁴Ω to 1 MΩ. The electric resistance of the conductive powder is defined herein as a value measured by a four-terminal method with electrode intervals of 1.5 mm. When the electric resistance is more than 1 MΩ, the conductive powder has too low conductivity, resulting in the actuator with poor efficiency. The conductive powder having electric resistance of less than 10⁴Ω cannot easily be produced.

The conductive powder 1a comprises a conductive polymer, which preferably has a conjugated structure. The conductive polymer having a conjugated structure is more preferably at least one selected from the group consisting of polypyrrole, polythiophene, polyaniline, polyacetylene and their derivatives, particularly polypyrrole. The polypyrrole powder compact 1 exhibits large extension and contraction when electric current is supplied.

The conductive powder 1a preferably comprises a dopant. A usual dopant, p-type or n-type, may be used. Examples of the p-type dopants include halogens such as Cl₂, Br₂, I₂, ICl, ICl₃, IBr, IF₃, etc.; Lewis acids such as PF₅, PF₆, BF₄, AsF₅, SbF₅, etc.; inorganic acids such as sulfuric acid, nitric acid, perchloric acid, etc.; and organic acids such as p-toluene sulfonic acid, etc; transition metal salts such as iron trichloride, titanium tetrachloride, iron sulfate, iron nitrate, iron perchloride, iron phosphate, iron sulfate, iron bromide, iron hydroxide, copper nitrate, copper sulfate, copper chloride, etc. Examples of the n-type dopants include alkali metals such as Li, Na, K, Rb, Cs, etc.; and alkaline earth metals such as Be, Mg, Ca, Sc, Ba, Ag, Eu, Yb, etc.

The amount of the conductive polymer in the conductive powder preferably 1-99.9% by mass, more preferably 30-99% by mass. When the conductive polymer is less than 1% by mass, the conductive powder absorbs and desorbs too small amounts of the electrolyte and water, resulting in the polymer actuator with too small displacement. When the conductive polymer is more than 99.9% by mass, the amount of the dopant such as a metal salt, etc. is too small to have enough conductivity. When the conductive polymer has an average particle size of more than 1 mm, it undesirably has too small area to be in contact with the ion donor 5 such as an electrolytic solution, etc., resulting in the polymer actuator with too poor response. The conductive polymer having an average particle size of less than 10 nm cannot easily be produced and handled.

The conductive powder 1a preferably contains conductive material such as carbon metals other than alkali metals and alkaline earths in addition to a conductive polymer and a dopant. The powder compact 1 containing the conductive material exhibits excellent conductivity. The metals other than alkali metals and alkaline earths are preferably iron, copper, nickel, titanium, zinc, chromium, aluminum, cobalt, gold, platinum, silver, manganese, tungsten, palladium, ruthenium or zirconium.

The production method of the conductive powder will be explained below, taking a conductive powder containing a conductive polymer and an oxidation polymerization catalyst for example. The conductive polymer can efficiently be synthesized by oxidation polymerization. When a monomer is dropped into an aqueous solution containing an oxidation polymerization catalyst and stirred, the monomer is polymerized with an oxidation polymerization catalyst taken thereinto. Thus, the conductive powder comprising a catalyst can be produced by the polymerization of the monomer in a solution containing the oxidation polymerization catalyst. The conductive powders comprising a conductive material such as dopant, carbon, etc. can be produced only to add the conductive material, in addition to an oxidation polymerization catalyst, to the solution for polymerization of the monomer.

Because the transition metal salt such as copper chloride, iron trichloride, etc. also functions as a dopant, in case such transition metal salt is used as a catalyst, another dopant is not required except for the catalyst. Of course, in case the dopant of the powder compact 1 does not function as a catalyst, an oxidation polymerization catalyst should be added except for the dopant. The oxidation polymerization catalyst is preferably dissolved in the aqueous solution, such that catalyst/monomer ratio is about 10/1 to 1/100 by mole. When the molar ratio is less than 1/100 by mole, efficient catalytic effect cannot be obtained. When the molar ratio is more than 10/1 by mole, the catalytic effect is not increased, and the surplus of the catalyst is useless.

The conductive material 1b preferably does not ionize when a voltage is applied. Specifically, it is preferably at least one selected from the group consisting of platinum, gold, palladium, nickel and carbon. The powder compact 1 comprising at least one selected from the group consisting of platinum, gold, palladium, nickel and carbon has enough conductivity. From the aspect of conductivity, carbon is preferably in the form of graphite, or carbon nanotube or nanohorn. In these specific examples, the conductive material 1b is most preferably platinum.

When the conductive material 1b is powdery, the conductive polymer preferably has an average particle size of 10 nm to 1 mm. When the conductive material 1b is in the form of fibers, it preferably has an average diameter of 1 nm to 1 mm and an average length of 10 nm to 2 mm. The powdery conductive material 1b and/or the fibrous conductive material 1b with such size are easily mixed with the conductive powder 1a. Thus, the conductive material 1b is well in contact with the conductive powder 1a, resulting in the powder compact 1 having enough conductivity.

The powder compact can be produced by integrally compressing the conductive powder 1a and the conductive material 1b other than the conductive powder, for instance, by charging the conductive powder 1a into a tablet mold, evacuating the mold, and compressing it at 700-900 MPa for about 3-10 minutes. When the powder compact 1 shown in FIG. 4 (a) is produced, a mixture of the conductive powder 1a with the conductive material 1b is charged into the tablet mold and compressed. The compacted conductive powder 1a extends or contracts when electric current is supplied, usable as the displacement of the actuator.

The work electrode 2 in contact with the powder compact 1 and the cell 4 is connected to a lead wire 21. The work electrode 2 is preferably bonded to the fixed end 11 of the powder compact 1 and an inner surface of the cell 4. With the work electrode 2 bonded to the fixed end 11 and the cell 4, the powder compact 1 can return to the original position while contracting after extension. The work electrode 2 may be bonded to the powder compact 1 and the fixed end 11 by an adhesive.

The work electrode 2 is preferably made of platinum, gold, silver, copper, nickel, stainless steel or carbon. The work electrode 2 is preferably as thick as 0.1 μm to 10 mm. The work electrode 2 can be formed on the powder compact 1 by chemical plating, electroplating, vapor deposition, sputtering, coating, pressure-bonding, welding, adhesion, etc. A surface of the work electrode 2 is preferably covered with a seal 20 made of an adhesive, etc. except for a portion not in contact with the powder compact 1, to prevent the work electrode 2 from touching the ion donor 5 and thus to prevent short-circuiting to the ion donor 5 by passing the powder compact 1.

The movable plate 3 is fixed to the driving end 12 of the powder compact 1. As shown in FIG. 2, the movable plate 3 does not cover substantially a lower half of the powder compact 1, lest that the movable plate 3 hinders the powder compact 1 from absorbing and desorbing the electrolyte, etc. in the ion donor 5. Though the movable plate 3 is in the form of a circular plate in the example shown in FIGS. 1 and 2, the form of the movable plate 3 is not particularly restrictive as long as it does not prevent the powder compact 1 from absorbing and desorbing the electrolyte, etc. A movable bar 8 is perpendicularly fixed to the movable plate 3 on the other side to the powder compact 1. The movable bar 8 penetrates through an opening 41 of the cell 4, and is movably supported by a bearing 42 disposed in the opening 41. When the powder compact 1 is driven by electric current supplied, the movable bar 8 moves. Accordingly, one end of the movable bar 8 is a driver part.

A box-shaped cell 4 contains the powder compact 1 vertically. The cell 4 has a slightly larger inner width than the outer diameter of the powder compact 1 so that the powder compact 1 can extend and contract in the cell 4 without friction with the inner face of the cell 4. Because a flowable ion donor 5 is filled in the cell 4, the opening 41 is sealed lest that the ion donor 5 leaks through the opening 41. The cell 4 is preferably made of glass, rubbers, thermoset polymers, ceramics, etc., the most preferably Teflon® or polyimide.

The ion donor 5 contains an electrolyte and/or a polymer. Examples of the electrolytes include sodium chloride, NaPF₆, sodium p-toluene sulfonate and sodium perchlorate. Examples of the polymers include polyethylene glycol and polyacrylic acid. Because polyethylene glycol and polyacrylic acid are amphiphatic, the ion donor 5 containing them easily enters the pores of the powder compact 1. The electrolyte and/or polymer also preferably functions as a binder for the powder compact 1.

The ion donor 5 should have such flowability as not to hinder the extension and contraction of the powder compact 1. The ion donor 5 is preferably in the form of a solution, a sol, a gel, a mixture of a solution and a sol, a mixture of a sol and a gel, or a mixture of a solution and a gel. The ion donor 5 is preferably in the form of a sol, a gel or a mixture thereof because of no leakage. A solvent and/or a dispersing medium for the ion donor 5 is preferably water. When the solvent and/or the dispersing medium are water, the ion donor 5 has large conductivity. The concentration of an aqueous electrolyte solution is preferably about 0.01-5 mol/L.

A spacer 60 laid between the counter electrode 6 and the powder compact 1 entirely covers the counter electrode 6. The spacer 60 has pluralities of pores 60a to keep the counter electrode 6 in touch with the ion donor 5. The counter electrode 6 and a reference electrode 7 are connected to respective lead wires 61, 71. The counter electrode 6 and the reference electrode 7 may be those generally used. Preferred materials for these electrodes may be platinum, gold, silver, copper, nickel, stainless steel, carbon, etc. Although the counter electrode 6 is a plate while the reference electrode 7 is a rod in the example shown in FIGS. 1 to 3, their shapes are not particularly restrictive. A line, rod or plate electrode is usable as the counter electrode 6 or the reference electrode 7.

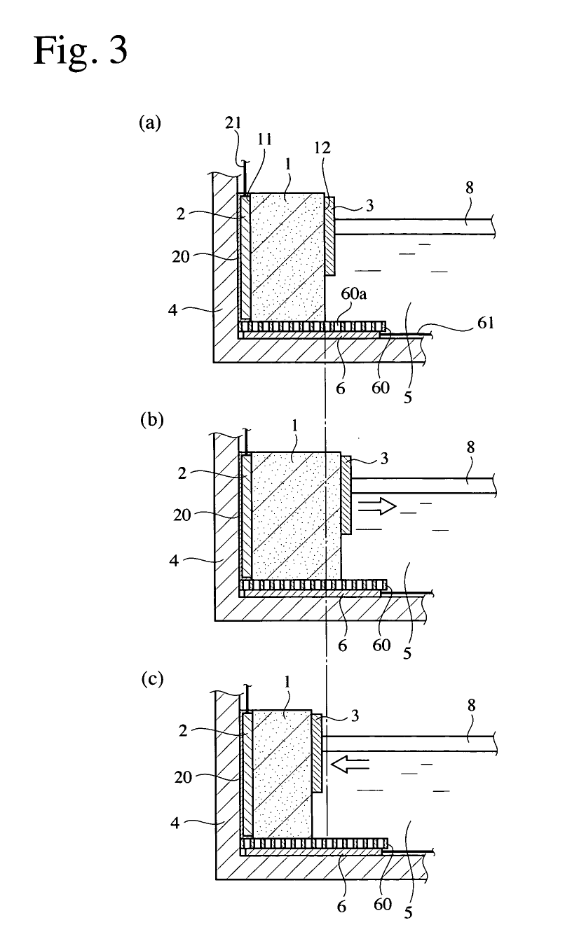

When electric current is supplied between the work electrode 2 and the counter electrode 6, the powder compact 1 extends or contracts, thereby moving the movable bar 8 fixed to the movable plate 3. FIG. 3(a) shows a state where no electric current is supplied When electric current is supplied to the work electrode 2, the work electrode 2 is charged positive, so that the powder compact 1 extends to move the movable bar 8 rightward in the figure [FIG. 3(b)]. When electric current is then supplied such that the work electrode 2 is charged negative, the powder compact 1 contracts to move the movable bar 8 leftward in the figure [FIG. 3(c)]. The powder compact 1 appears to extend because the conductive polymer in the powder compact 1 is oxidized by electric current supplied to absorb the electrolyte, the solvent, etc. in the ion donor 5, while contracting because the conductive polymer is reduced to desorb them. How the powder compact 1 extends and contracts may change depending on the types of the conductive polymer in the powder compact 1 and the electrolyte, etc. in the ion donor 5, and their combinations. In other words, depending on the types of the conductive polymer and the ion donor, the powder compact 1 may extend when electric current is supplied such that work electrode 2 becomes negative, and contract when electric current is supplied such that the work electrode 2 becomes positive.

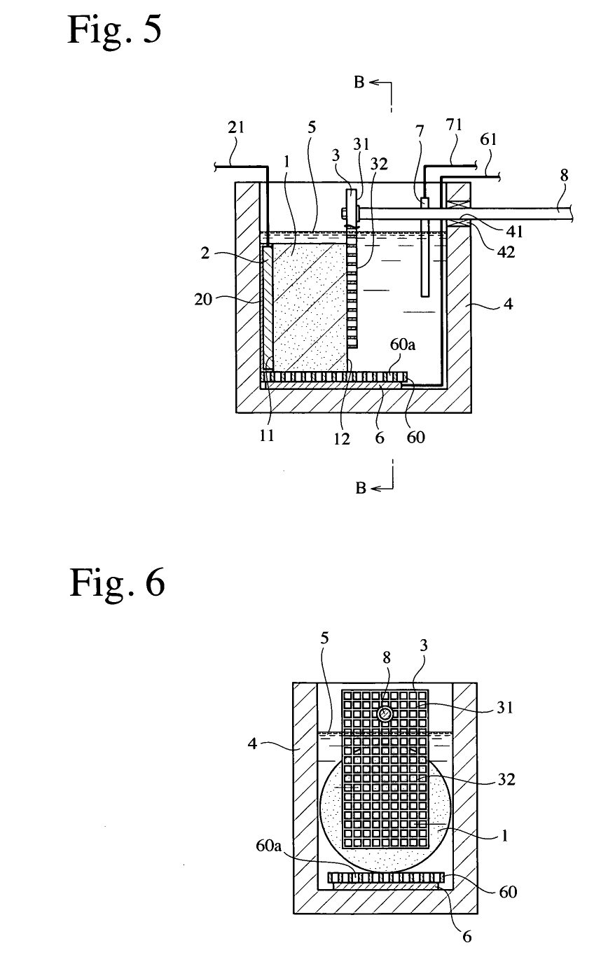

The polymer actuator shown in FIGS. 5 and 6 is substantially the same as shown in FIGS. 1-3, except that a movable plate 3 is fixed to a powder compact 1 such that its upper portion 31 projects from an ion donor 5. Accordingly, only differences will be explained below. As shown in FIGS. 5 and 6, a lower portion 32 of the movable plate 3 is fixed to the powder compact 1. The movable plate 3 is in a net shape, so that it does not prevent the powder compact 1 from absorbing and desorbing the ion donor 5. The movable plate 3 moves in response to the extension and contraction of the powder compact 1.

The movable bar 8 is fixed to the upper portion 31 of the movable plate 3. A cell 4 has an opening 41 for horizontally supporting a movable bar 8 at a position higher than the powder compact 1 and a surface of the ion donor 5. Thus, even if the powder compact 1 is entirely immersed in the ion donor 5 in the cell 4, there is no need of sealing the opening 41. The polymer actuator having the movable bar 8 not soaked in the ion donor 5 suffers relatively small friction resistance when it drives.

When electric current is supplied between the work electrode 2 and the counter electrode 6, the conductive polymer in the powder compact 1 absorbs or desorbs the ion donor 5, so that the powder compact 1 extends or contracts to move the movable bar 8 fixed to the movable plate 3. With the net-shaped movable plate 3, the powder compact 1 has a large contact area with the ion donor 5, thereby quickly absorbing or desorbing the electrolyte, the solvent, etc. in the ion donor 5. Accordingly, the polymer actuator shows excellent response.

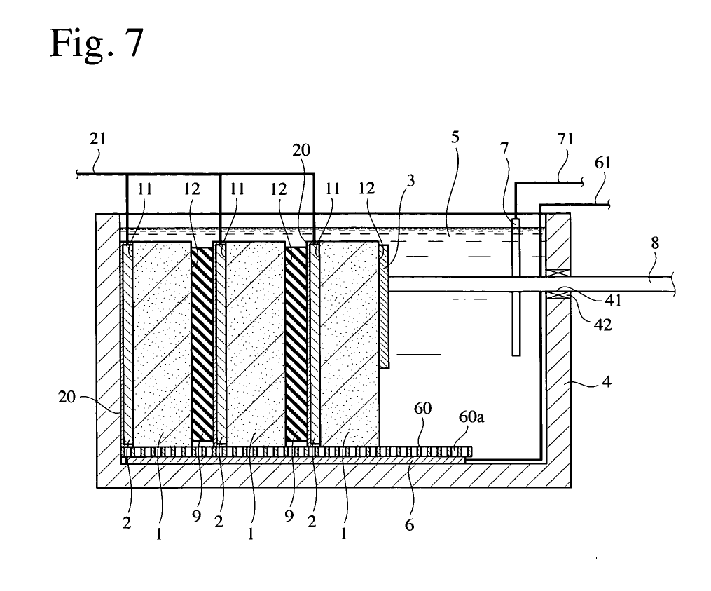

The polymer actuator shown in FIG. 7 is substantially the same as shown in FIGS. 1 to 3 except for comprising pluralities of work electrodes 2 and powder compacts 1 arranged in tandem in the cell 4. Accordingly, only differences will be explained below. In the example shown in FIG. 7, three work electrodes 2 and three powder compacts 1 are contained in one cell 4, though not restrictive. The numbers of the work electrodes 2 and the powder compacts 1 contained in one cell 4 may respectively be 2, or 4 or more.

The cell 4 contains two sets of work electrodes 2, powder compacts 1, and planar insulators 9, and additionally a work electrode 2 and a powder compact 1 in this order. Each fixed end 11 is bonded to each work electrode 2, and each driving end 12 is bonded to each insulator 9, which is bonded to each work electrode 2, so that when the powder compacts 1 extend and then contract by the supply of electric current, the powder compacts 1 and the work electrodes 2 return to their original positions. A movable plate 3 is fixed to a driving end 12 of the powder compact 1 on the side of the counter electrode 6. Because the diameter of each insulator 9 is slightly smaller than the inner width of the cell 4, the insulator 9 is not in contact with the cell 4. Accordingly, there is no friction between the insulators 9 and the cell 4, when the powder compact 1 extends or contracts.

When electric current is supplied between each work electrode 2 and the counter electrode 6, each powder compact 1 absorbs or releases the ion donor 5 to extend or contract, resulting in moving the movable plate 3 fixed to the movable bar 8. This piezoelectric polymer comprising plural powder compacts 1 arranged in tandem is thick in the displacement direction (moving direction of the movable bar 8), thereby producing large displacement. The laminated powder compacts 1 have large contact area with the ion donor 5, resulting in excellent response.

The present invention will be explained in more detail referring to Examples below without intention of restricting the present invention thereto.

### EXAMPLE 1

113.62 g of iron trichloride and 2.79 g of iron dichloride were dissolved in 100 mL of methanol. While stirring the resultant solution at 0° C., 4.7 g of pyrrole vacuum distilled was slowly dropped. After stirring at 0° C. for 1 hour after the completion of dropping pyrrole, the resultant black precipitate was filtered out, and washed with ethanol and then distilled water to obtain polypyrrole powder, which was vacuum-dried at room temperature for 12 hours.

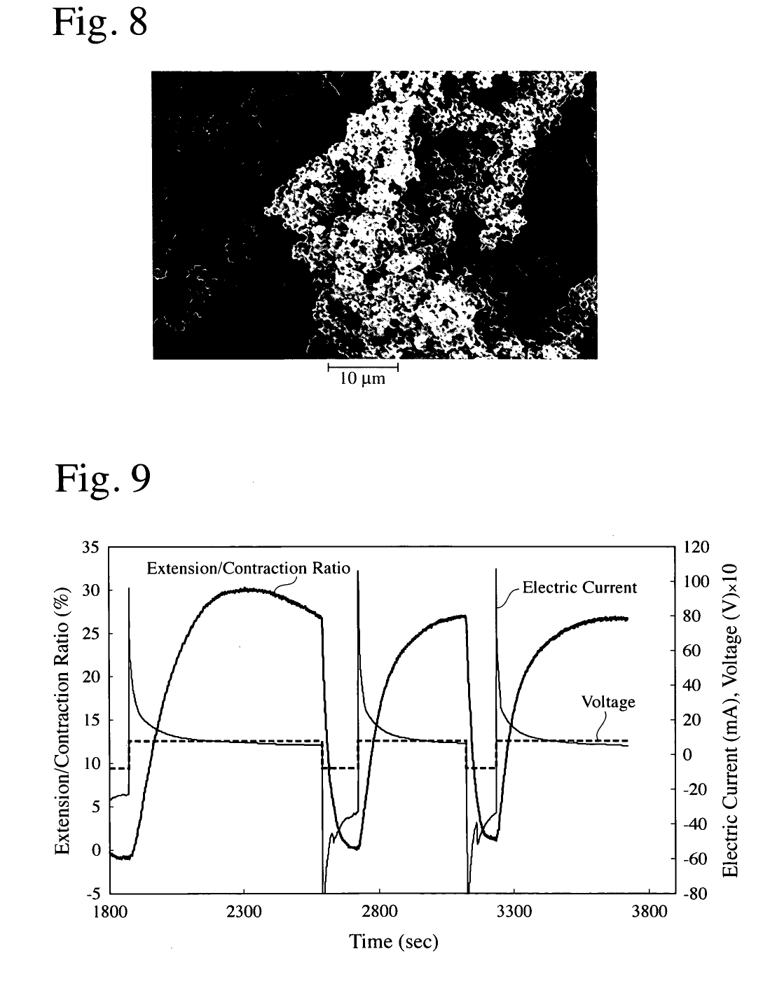

47.67 mg of the polypyrrole powder and 2.93 mg of platinum powder having an average diameter of 0.8 μm available from Furuya Metal Co., Ltd. were charged into an IR tablet mold having a diameter of 10 mm, and compressed at a pressure of 6 tons for 5 minutes while evacuating, to form a platinum-containing polypyrrole disk. FIG. 8 is a scanning electron photomicrograph of the platinum powder. The platinum-containing polypyrrole disk had a thickness of 0.495 mm, a weight of 50.6 mg and an electric conductivity of 55.6 S/cm.

A platinum plate having a thickness of 30 μm was attached to one surface of this platinum-containing polypyrrole disk, and a lead is connected to the platinum plate. The resultant assembly was used to constitute the actuator shown in FIGS. 1 and 2. Voltage of +0.8 V and −0.8 V was alternately applied to this actuator to measure electric current and extension/contraction ratios (displacement) using a laser displacement sensor. The measurement conditions were as follows.

| | |
|---|---|
| Ion donor | Aqueous solution of NaPF₆ (1 mol/L), |
| Work electrode | Platinum plate, |
| Counter electrode | Platinum plate, and |
| Reference electrode | Ag/AgCl. |

### EXAMPLE 2

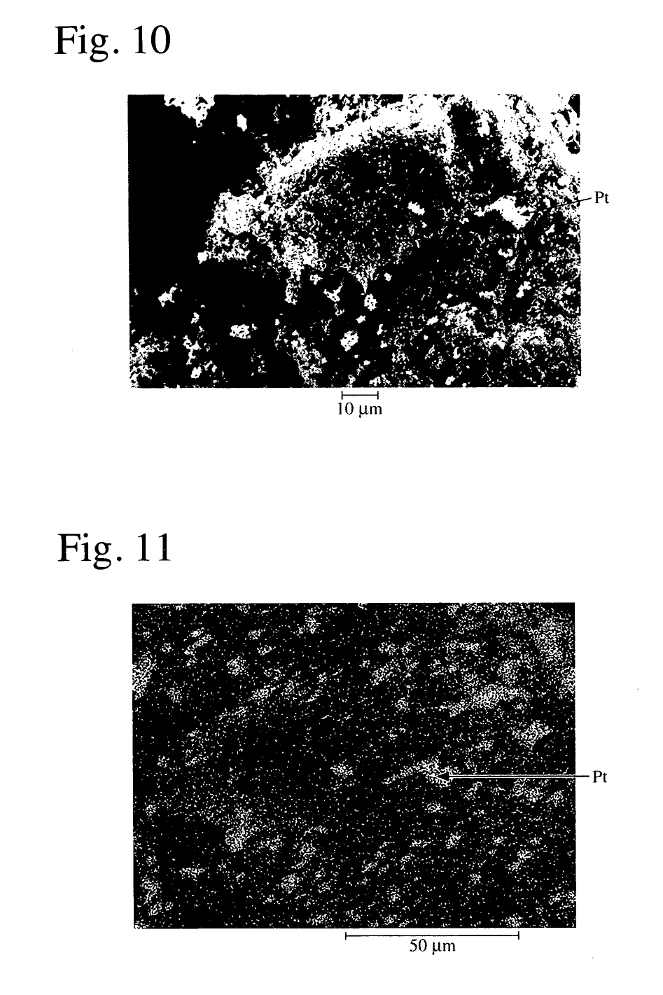

The platinum-containing polypyrrole disk was produced in the same manner as in Example 1 except that the ratio of the platinum powder to the powder compact was 15% by mass. The platinum-containing polypyrrole disk had a thickness of 0.497 mm, a weight of 59.5 mg, an electric conductivity of 85.6 S/cm. The electric current and extension/contraction ratios were measured on the actuator assembled using this platinum-containing polypyrrole disk in the same manner as in Example 1. The results are shown in FIG. 9. FIG. 10 is a scanning electron photomicrograph showing a surface of the platinum-containing polypyrrole disk, and FIG. 11 is its SEM-EDX photomicrograph. White spots in the photomicrograph are platinum powder.

### EXAMPLES 3 TO 5

Platinum-containing polypyrrole disks were produced in the same manner as in Example 1 except that the mass ratio of platinum powder to the powder compact was changed as shown in Table 1, and their extension/contraction ratios were measured. The mass, thickness and electric conductivity of each platinum-containing polypyrrole disk are shown in Table 1.

TABLE 1

| | | | | Electric |
|---|---|---|---|---|
| | Content of Pt | Mass of | Thickness of | Conductivity |
| No. | (% by Mass) | Disk (g) | Disk (mm) | (S/cm) |
| Example | 11 | 53.6 | 0.535 | 60.1 |
| 3 | | | | |
| Example | 22 | 62.3 | 0.517 | 90.8 |
| 4 | | | | |
| Example | 50 | 99.4 | 0.551 | 302.1 |
| 5 | | | | |

### COMPARATIVE EXAMPLE 1

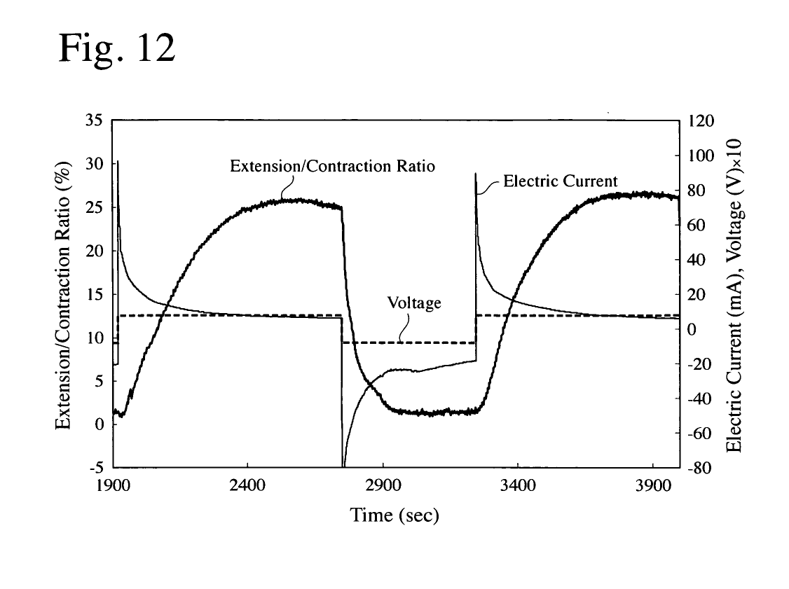

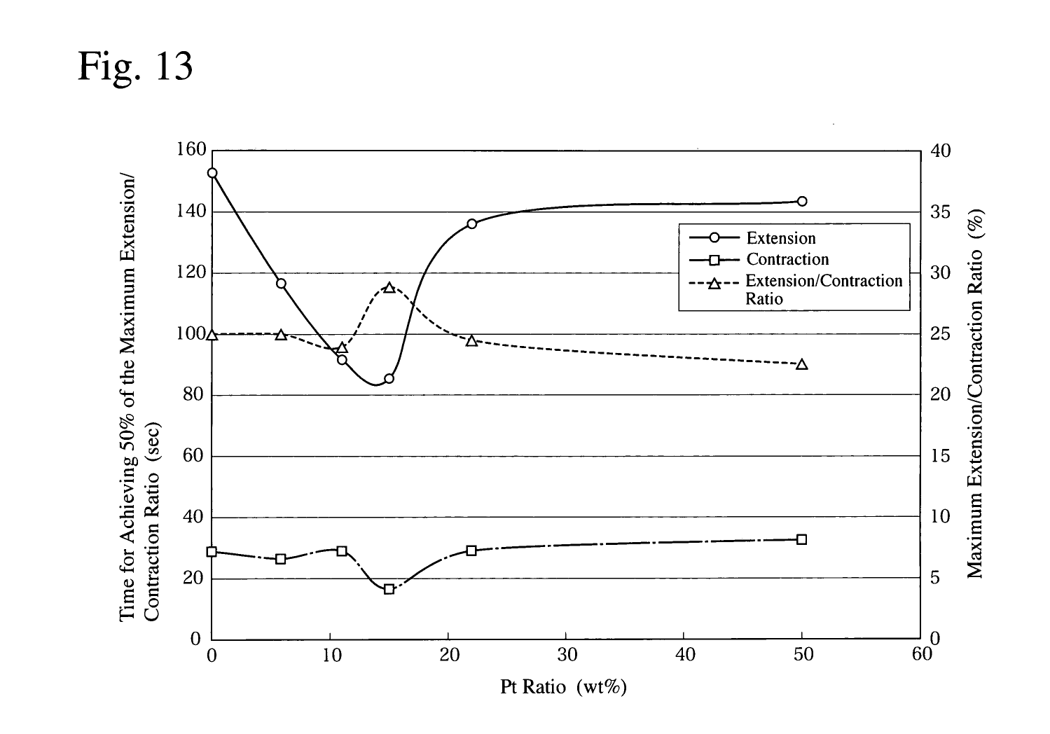

The polypyrrole disk was produced in the same manner as in Example 1 except that only polypyrrole powder was charged into an IR tablet mold without platinum powder. The polypyrrole disk had a thickness of 0.556 mm, a mass of 50.4 mg and an electric conductivity of 68.9 S/cm. The actuator was assembled using this polypyrrole disk in the same manner as in Example 1, and the generated electric current and extension/contraction ratio were measured. The results are shown in FIG. 12.

The time for achieving 50% of the maximum extension/contraction ratio (simply “50-%-achieving time”) was determined from the results of Examples 1 to 5 and Comparative Example 1, and the 50-%-achieving time and the maximum extension/contraction ratio were plotted as a function of the platinum ratio (% by mass) in FIG. 13. FIG. 13 shows that the 50-%-achieving time and the maximum extension/contraction ratio depend on the platinum ratio. The platinum ratio of 15% by mass provided the minimum 50-%-achieving time, as short as half when the platinum ratio was 0% by mass, meaning that a response speed doubled. The platinum ratio of 15% by mass provided the platinum-containing polypyrrole disk with the maximum extension/contraction ratio.

### EFFECT OF THE INVENTION

Because the polymer actuator of the present invention comprises a powder compact comprising a conductive powder and a conductive material other than it, an ion donor, a work electrode, and a counter electrode, the conductive powder absorbs or desorbs the ion donor voltage is applied between the work electrode and the counter electrode, so that the powder compact extends or contracts. Accordingly, the polymer actuator generates large displacement and power. Because the displacement is linear, it can be easily controlled. Moreover, the powder compact does not easily peel off from the electrode, and does not deteriorate even after repeated use. Because the powder compact generates large power not only when it contracts but also when it extends, the displacement at the time of extension can be utilized. The powder compact comprising a conductive material other then the conductive powder shows excellent response, and generates large displacement and power. Further, because the powdery conductive polymer can be formed by oxidation polymerization, the polymer actuator of the present invention can be mass-produced at a low cost.

1. A polymer actuator comprising a conductive powder compact, an ion donor, a work electrode and a counter electrode, wherein said powder compact comprises conductive powder containing a conductive polymer and a conductive material other than said conductive powder whereby said actuator contracts or extends by voltage applied between said work electrode and said counter electrode.

2. The polymer actuator according to claim 1, wherein said conductive polymer has a conjugated structure.

3. The polymer actuator according to claim 1, wherein said conductive polymer is at least one selected from the group consisting of polypyrrole, polythiophene, polyaniline, polyacetylene and their derivatives.

4. The polymer actuator according to any one of claims 1, wherein said conductive material is in a powdery, net and/or porous form.

5. The polymer actuator according to any one of claims 1, wherein said conductive material is at least one selected from the group consisting of platinum, gold, palladium, nickel and carbon.

6. The polymer actuator according to any one of claims 1, wherein said ion donor is in the form of a solution, a sol, a gel or a combination thereof.

7. The polymer actuator according to any one of claims 1, wherein said ion donor contains an amphiphatic compound.

8. The polymer actuator according to any one of claims 1, wherein said ion donor has a binder function.

9. The polymer actuator according to any one of claims 1, wherein said work electrode is in contact with said powder compact, said counter electrode is disposed in said ion donor at a position separate from said powder compact.

10. The polymer actuator according to any one of claims 1, having pluralities of said powder compacts and pluralities of said work electrodes alternately arranged in tandem.

11. The polymer actuator according to any one of claims 1, wherein the ratio of said conductive material to said powder compact is 1 to 99% by mass.

12. The polymer actuator according to any one of claims 1, wherein the electric resistance of said conductive powder is 10⁻⁴Ω to 1 MΩ.

13. The polymer actuator according to any one of claims 1, wherein said conductive powder has an average particle size of 10 nm to 1 mm.

14. The polymer actuator according to any one of claims 1, wherein said powder compact has an electric conductivity of 10⁻³ to 10⁵ S/cm.

15. The polymer actuator according to claim 2, wherein said conductive polymer is at least one selected from the group consisting of polypyrrole, polythiophene, polyaniline, polyacetylene and their derivatives.
